(19) United States
(12) Patent Application Publication
(10) Pub. No.: US 2008/0243806 A1
(43) Pub. Date: Oct. 2, 2008

(54) Accessing information on portable cellular electronic devices

(76) Inventor: Roger Dalal, Palm City, FL (US)

Correspondence Address: MCHALE & SLAVIN, P.A., 2855 PGA BLVD, PALM BEACH GARDENS, FL, 33410, US

(21) Appl. No.: 11/690,930

(22) Filed: Mar. 26, 2007

(51) Int. Cl. G06F 17/30

(52) U.S. Cl. 707/5

(57) ABSTRACT

A method, performed by software executing on the processor of a portable cellular electronic device, which allows for the retrieval of personal, reference, and remote information with a minimum of operator interaction. A user interface is utilized to search and act on such information. Furthermore, additional features designed to assist the user of such devices is proposed.

### FIELD OF THE INVENTION

The present invention relates to the retrieval and display of personal, reference and remote information on a portable electronic device with a minimum of operator interaction. More specifically, the present invention is directed to a method, performed by software, for retrieving and effectively organizing the information on a portable electronic device such as a personal digital assistant (PDA), cell phone, smartphone, etc.

### BACKGROUND OF THE INVENTION

Electronic devices have become smaller, more portable, and increasingly combine the features and abilities of previously separate devices. For example, many personal digital assistants have been enhanced with cellular telephone capability, resulting in “smartphones.” These smartphones, despite their small, handheld size, rival desktop computers in ability and power. They frequently feature advanced microprocessors, alphanumeric keyboards, and smaller screens that are possibly touch sensitive. They also feature supplementary input controls such as dedicated function buttons, navigation pads, and/or scroll wheels and bars, and they function under the control of a number of operating systems (OS), including but not limited to, the Access/Palm OS, Microsoft Windows Mobile, Symbian, Linux, the RIM/Blackberry OS, and/or some version of the Apple Mac OS. Utilizing these operating systems smartphones, in addition to making phone calls, can browse the Internet, send and receive e-mails, play digital audio and video files, take and manage digital photographic files, and organize and store personal information such as contacts, phone calls, appointments, and tasks.

Furthermore, due to the availability of fast, wireless access to the Internet via cellular networks, smartphone devices can access great volumes of data located remotely on the Internet. This data may include public information (word definitions, area codes, zip codes, and airport codes) or information aggregated by Internet content providers such as residential and business telephone directories, geographic mapping services, weather information, airline flight information, etc. Smartphones can also perform expedient web searches and queries. Unfortunately, if the user wishes to access such information via the Internet, the user must typically first launch a web browser application, type in a URL address (assuming the user knows the address), enter the search criteria for the information desired, and then view the results in a manner usually formatted for a much larger screen. In addition, there is frequently not an intuitive way to permanently store the search results on the device, if desired (i.e. copy the result of a business directory search to the user's list of stored contacts).

The usual method of operating such devices requires that the user first select a specific application (e.g. contact management program, calendaring program, etc.) to access a certain type of information. Then the selected application is opened and used to create, edit and/or find records. Finally, commands or actions required to create or manipulate records are chosen from menu options. This methodology forces the user into executing a tedious cycle of frequently very small button or control presses in order to accomplish the desired intent. Additionally, current devices and software make no provision to aid the user in retrieving frequently accessed records multiple times (a favorite contact's phone number, for example) because they typically display information alphabetically, rather than by how frequently records are used.

Therefore, because smartphones are increasingly more powerful (while their form factor is generally shrinking), and can access growing amounts of data, the consumer faces many problems in effectively operating these devices and in retrieving and organizing the information they are able to obtain. Because they are handheld, portable devices, as previously stated the keyboard buttons and other controls are very small, screen sizes are only a few inches, and the operating systems mentioned contain limited features. Additionally, other drawbacks include a difficulty in viewing information possibly formatted for larger screens, and/or an extended cycle of small button or control activations required to accomplish a desired intent. These disadvantages can result in user frustration, possibly limiting the user's ability to realize the full potential of the device.

### DESCRIPTION OF THE PRIOR ART

U.S. Pat. No. 6,392,640 discloses a device which employs a menu and thumbwheel to select and enter text into certain specialized miniature information appliances such as PDAs and handheld wireless Web access devices. The user first scrolls down a menu of multiple letters and selects the groups which contain the letters of the desired word. The device also employs software which utilizes a dictionary to display those words consistent with the user's input on another menu. The then selects the desired word and returns to the first menu to obtain the next word. Using this technique a text message or search request can be composed for electronic mail, directory lookup or Web browsing. This is a very time consuming process and requires the user to scroll through many menus prior to reaching the desired result.

U.S. Published Application No. 2005/0283724 discloses the entry of text words and phrases in a portable electronic device, such as a cell phone, based on a predictive text dictionary. The device includes an interface by which the user may select a specific category to group together certain commonly used words so that it is easier and faster for the device to predict the next word or phrase that the user desires to input. The text input is used mainly for communication purposes rather than seeking information. In addition the preprogrammed categories may not be helpful in the user obtaining the information that they are seeking.

### SUMMARY OF THE INVENTION

The invention provides a software driven user interface for a smartphone, cell phone, or handheld portable computer that typically includes features such as wireless voice and data transmission, an alphanumeric keyboard and possibly a touch sensitive screen. The invention provides a quick and efficient system and method for controlling the functions of the device. This includes selection of software applications, a means for accessing diverse files containing records stored both locally on the device and remotely on servers connectable over the Internet, and a method for initiating predefined actions on records once located.

Accordingly, it is an objective of the invention to provide a database that tracks and organizes certain files (applications, preference settings, memos, digital audio and video files, etc.) and personal information (contacts, appointments, tasks, browser bookmarks, etc.), hereinafter collectively referred to as “records”, that may be stored on an electronic device such as a smartphone or a PDA, either within the device's fixed memory or on removable memory cards. The database will be indexed in such a way as to allow for the rapid lookup of applicable records based upon user key presses and to quickly present matching records, if any, in an order designed to put records mostly likely desired first. The database will track usage to help determine the order that records are presented to the user, increasing each record's usage count as it is accessed. Therefore, the more often a record is used, the higher in search lists the record will appear.

It is a further objective of the invention to enable a user to search for a record by entering the first letter or letters of the item desired. Each record will typically have several keys in the database index that can be used to search for the record. For example, a contact named “John Smith” might be indexed by the letter combinations “JS”, “JO”, “SM”, “JSM”, or some combination of letters in the contact's company name, if available. These keys will be sorted to generate the index file for the database. As keys are pressed, the invention will filter the database using the index file based on the letters or numbers entered in order to determine a list of matching records.

It is another objective of the invention to assign applicable actions (for example, launch application, dial number, send e-mail, delete record, etc.) to specific keys of an alphanumeric keyboard, if available. The invention shall make such actions available to the user immediately after locating and confirming a desired record in the database, allowing actions to be quickly performed without a need to navigate interface menus.

It is a further objective of the invention to provide a method in the software to update the database as a user adds, modifies or deletes files and records. Also, information in the database will be modified as the user conducts searches on the Internet and accesses remote Web services.

It is yet another objective of the invention to provide for removal of the memory card from the device in order to update the database (if located on the memory card) utilizing a computer connected to the Internet and provided with software designed to update the database.

It is a still further objective of the invention to provide connections, both hard wire and wirelessly, on the device which enables it to be connected to another computer connected to the Internet and provided with software designed to update the information in the catalogue.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a flow chart of the invention;

FIG. 2A is a screen shot depicting a possible main screen if not already provided by the device's operating system;

FIG. 2B is an indication of the functions of the 5 way button and other controls relating to the screen in FIG. 2A;

FIG. 3A is a screen shot depicting a search of all contacts records;

FIG. 3B is an indication of the functions of the 5 way button relating to the screen in FIG. 3A;

FIG. 4A is a screen shot of a two letter search of contacts records only;

FIG. 4B is an indication of the functions of the 5 way button and another control relating to the screen in FIG. 4A.

FIG. 5A is a screen shot depicting the information regarding an individual contact record;

FIG. 5B is an indication of the functions of the 5 way button and other controls relating to the screen in FIG. 5A;

FIG. 6A is a screen shot depicting the screen in FIG. 5A with the action list lowered;

FIG. 6B is an indication of the functions of the 5 way button and another control relating to the screen in FIG. 6A;

FIG. 7A is a screen shot depicting the results of a three letter search of the database;

FIG. 7B is an indication of the functions of the 5 way button and other control relating to the screen in FIG. 7A;

FIG. 8A is a screen shot of the results obtained from an airport search;

FIG. 8B is an indication of the functions of the 5 way button and other control relating to the screen in FIG. 8A;

FIG. 9A is a screen shot of the results obtained from a specific airline flight search;

FIG. 9B is an indication of the functions of the 5 way button and other control relating to the screen in FIG. 9A;

FIG. 10A is a screen shot of the result when the requested information cannot be matched to records in the database files and

FIG. 10B is an indication of the functions of the 5 way button and other controls relating to the screen in FIG. 10A.

### DETAILED DESCRIPTION OF THE INVENTION

The invention comprises software running on an electronic device designed to store information, run software applications, allow retrieval of stored information, provide access to the Internet, and make and receive cellular telephone calls. Currently, many cellular telephones have been provided with Internet access thus permitting the user to search the Internet for Web sites which contain information. The user is then able to search these Web sites for the information they are seeking. Recently PDAs have been provided with cellular telephone capability. These combination PDA and cellular phones are commonly known as smartphones.

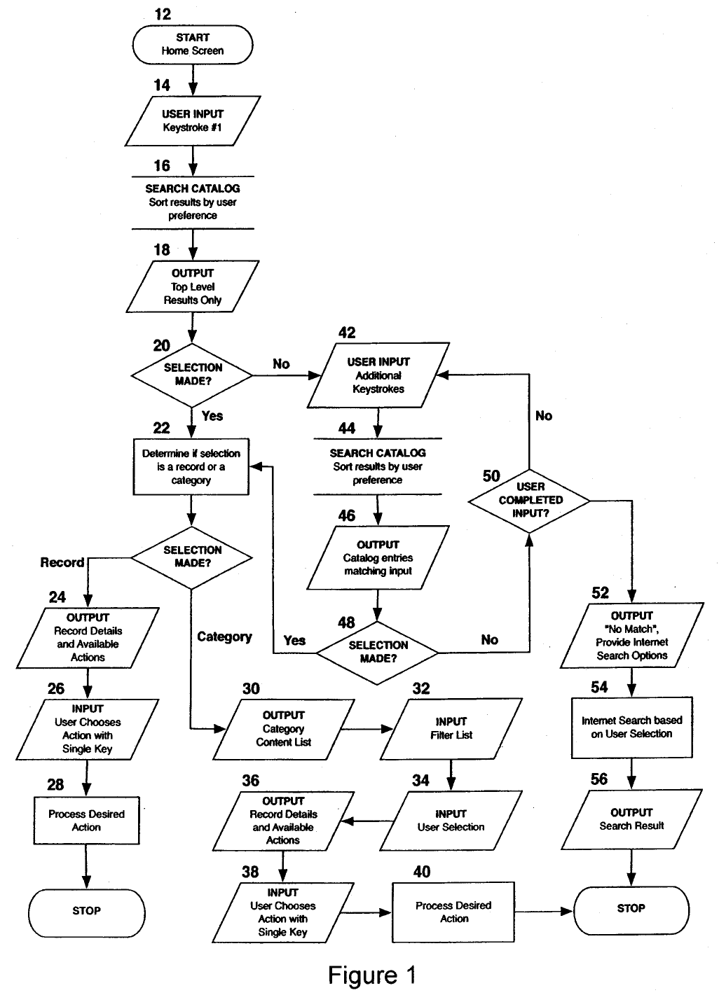

With reference to FIGS. 1-10 a preferred embodiment of the invention will now be described in the context of a smartphone. The presently described invention is software executing on an electronic device, preferably a smartphone, which contains a database which tracks and organizes certain files. These files can be applications, preference settings, memos, digital video and audio files, and personal information such as phone calls, contacts, appointments, tasks, Internet browser bookmarks, etc. This database is stored on the smartphone, either in the device's memory, hard drive, or on a removable memory card. Entries within the database are indexed such that information is readily retrievable without having to open and activate applications or enter long, specific search requests. These entries are readily retrievable using just a few keystrokes on the keyboard of the device.

FIG. 1 is a flowchart illustrating the operation of the software on the invention generally indicated as 10. After the smartphone is turned on a home screen appears at 12. One possible implementation of a home screen (if not already provided by the operating system) is illustrated in FIG. 2A. From here the user can enter specific search criteria on the keyboard of the smartphone. The user preferably enters a single letter or keystroke at 14. Records located within the database index file are searched at 16 and those records with keys in the index file that contain the single letter or keystroke entered are displayed at 18. The results are displayed in a specific order. The order may be predetermined by the software or it may be determined by a preference of the user. The preferred order shall be based on how frequently records were accessed previously. Next a decision is made at 20 by the user. The results returned by the search are what the user wanted or additional information is required necessitating further searching.

If the information is what the user wants then operation proceeds to step 22 wherein the software determines if the desired selection is an application, a record or a category of records. If the information is an application or a record, then details of the application or record are displayed and actions available to the user are offered at 24. The user can then initiate an action with a single keystroke at 26 and the action is processed and carried out at 28.

If the information is a category then a list of the contents of that specific are presented to the user at 30. The contents are filtered down to a list. The list is displayed according to preferences determined by the software or by the user at 32. The user then makes a selection at 34. The details of the selection and further actions available to the user are displayed at 36. The user can then select a specific action with a single keystroke at 38 and the action will be carried out at 40.

If the results returned by the initial search are not satisfactory a decision is made at 20 to further modify the search. The user can add an additional letter, number or symbol to the search at 42 and a new search of the database or catalog is conducted at 44. The results are sorted by the software's preference or the user's preference at 44 and the results are displayed at 46. The user makes another decision at 48. If the search results are satisfactory the process proceeds back to step 22. If the results are not satisfactory, a determination is made at 50 whether additional input is required by the user or the user has completed their search. If additional input is required the process is returned to step 42. If the search is complete and there will be no additional input the software recognizes this and provides an indication at 52 to this effect. Different Internet search options are presented to the user at 52 also. A search is entered by the user at 54 and the results are displayed at 56. These results depend on the type of search and the search engine that the user employs.

FIG. 2A is a screen shot of the main screen which appears when the electronic device is turned on. This main screen is an example of one embodiment, albeit non-limiting, of the present invention. Electronic devices which employ different operating systems would have different information on their main screen. This screen provides the user with information regarding the current location of the device, which is determined from the identification of the cell tower to which the device is currently connected, the current date and the temperature forecast in an upper portion 60 of the screen. At the top of the screen is a bar which displays the status of various features of the smartphone and also provides access to additional features of the phone. Beginning at the left, the current temperature is displayed at 62. The Bluetooth status of the device is displayed at 64. The current status and number of e-mails are indicated at 66. The current status and number of voice mails are indicated at 68. The number of missed phone calls in indicated at 70. The strength of the battery of the device is indicated at 72. The strength of the cell phone signal is indicated at 74. The current time is indicated at 76.

Below the upper portion 60 of the screen is an area 78 which contains a list of appointments that the user has for the current day. When the area 80 is activated by touching the screen or by other means, the user is able to scroll through the list of appointments for the current day. FIG. 2B illustrates the various controls available to the main screen 2A. The smartphone or electronic device is provided with a 5 button, not shown. This is a common control used on many electronic devices. When the center portion of the 5 way button is pushed the item which is highlighted on the screen is selected and may also be edited. When the up or down arrows of the 5 way button are activated the user can scroll up or down through the items displayed on the screen. If the right arrow is selected the “Content” menu will appear. This is normally the current appointments, current tasks, missed calls, messaging and favorites. All of these items can be displayed on the screen and can be scrolled through utilizing the side rocker page up/down control 82 located on the right side of the screen. If the left arrow is selected the filters, which control how certain items are displayed, can be changed.

Below area 78 is area 84 which contains a list of current tasks for the user. The tasks can be highlighted and further details of the task revealed. When area 86 is activated the task screen is activated. The next portion of the screen 86 contains phone calls which the user did not answer. This screen displays who the call was from, the day and time of the missed phone call. The next portion of the screen, not shown, contains information with respect to messaging. E-mails and voice mails are accessible from this portion of the screen. Finally the last portion of the main screen is whichever additional feature the user wants. A bar 88 at the bottom of the main screen contains virtual buttons 90 which connect the user to their home, workplace of voice mail. These connections can be changed by the user and this feature can also be turned off.

To further illustrate the invention, detailed explanations of various operations are herein provided. For example, upon entry of a letter, i.e. “C”, all records which begin with the letter “C” are retrieved. For instance, an application such as Calendar or Contact could be opened; a category such as Cities could be retrieved (information pertaining to different cities) or a record could be retrieved such as Citigroup (a company whose stock symbol begins with “C”). The user can also set their preferences, in this case the hierarchy of display, to select one of these, for example Contacts, to always be retrieved and displayed first. Alternatively, the hierarchy of display can be based on the frequency of use of the file, i.e. the files which are utilized the most will be displayed first and the remaining files displayed in a descending order of their frequency of use. This eliminates the user having to navigate through other application, category or information files that are used less frequently before gaining access to the more frequently used and requested files.

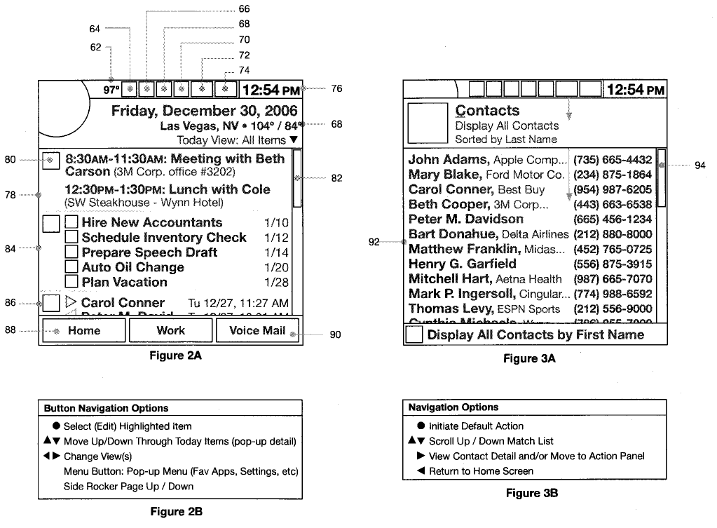

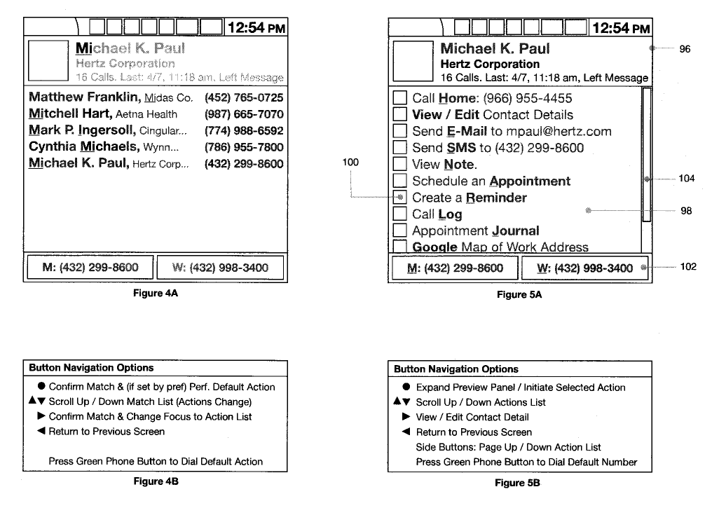

After the user selects an application, category or information record the user is then presented with another list of choices relating to that particular application, category or information file. For example, as illustrated in FIG. 3A, if Contacts was chosen then a list of alphabetically arranged persons would be presented to the user and displayed at 92. The upper portion 94 of the screen indicates that the Contacts application has been accessed and the results are displayed alphabetically by the last name. The keys which the user now activates or presses would only pertain to the Contacts application. For example, if the user wanted the contact information for a person named Michael Paul they could scroll down an alphabetical list of all the contacts or persons whose information is located in the Contract application utilizing the up or down arrows on the 5 way button and select Michael Paul once he was displayed on the list and highlighted, as illustrated in FIG. 3B. The user could also use the scroll bar 94 on the right side of the screen. They could also select him by touching the screen adjacent his name if the smartphone had touch screen technology. Finally, they could enter the letters “MI” on the keyboard. All the contacts whose name began with “MI” would be individually displayed on the screen, as illustrated in FIG. 4A. The different individuals are highlighted on this screen with the use of the up and down arrows on the 5 way button, as illustrated in FIG. 4B. If this was the individual that the user wanted, they would select this individual utilizing the right arrow of the 5 way button. If the user was not satisfied with the information presented on the screen they could return to the previous screen by utilizing the left arrow of the 5 way button. Once an individual is selected the search is stopped and the user to proceeds to the next choice of actions. If this was not the desired individual the user would continue to enter letters spelling the individual's name until the desired individual was retrieved. Then the information for these persons would be presented to the user. The software could also be designed so that the most frequently accessed results appeared first. In this case if the user needed the contact information for Michael Paul this information would be displayed first once the Contact application was accessed.

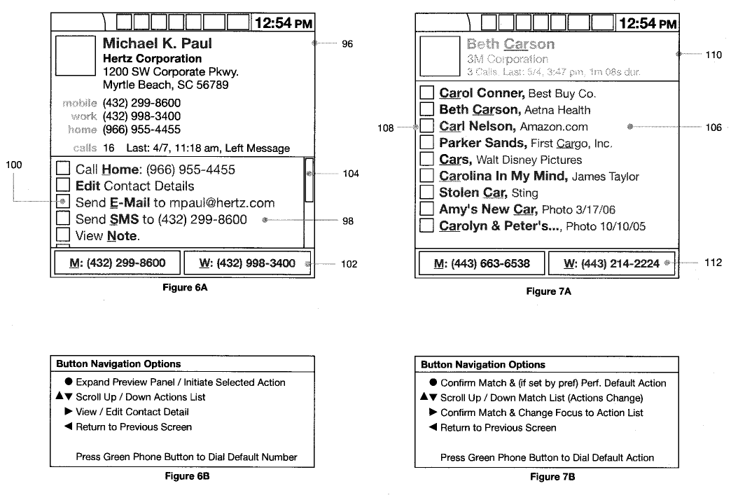

When an individual contact is selected by highlighting the individual and then pressing the right arrow of the 5 way button, the contact's name, place of business and information regarding the history of the user's contact with this individual is also displayed, as illustrated in FIGS. 5A and 6A. FIGS. 5A and 6A illustrate a display screen for each individual. This is also known as an action list for an individual. An upper portion 96 of the screen contains basic information with respect to the individual. Their name, their place of business, their phone numbers, the number of times they have been contacted in the past, the date and time of the last contact, and the duration of the phone call or if a voice mail was left. For example when Michael Paul is accessed, the user is informed that he has contacted this individual 16 times in the past, the last time that the user tried to contact the individual was on 4/7 at 11:18 AM and a message was left by the user. The upper portion of the screen can be expanded, as illustrated in FIG. 6A, revealing all the information pertaining to the selected contact person. Below this is another display 98 which contains a list of optional actions the user may now perform. Each different action has an action box 100 positioned to its left. Activation of the box will perform the action indicated to the right of the box. Additionally each action contains a highlighted or bolded word. This word begins with a letter which is also underlined. This letter indicates which key should be pressed to perform the desired action. For example, to call the individual at his Home the “H” key on the keyboard should be pressed. The phone would then dial the individuals' home phone number. To schedule an Appointment with the individual the “A” key on the keyboard should be pressed. The user's journal would then appear on the screen and an appointment with this individual could be scheduled. If the user wanted directions to the individual's work place he would press the “G” key for Google Map of Work Address. This would allow the user to access Google™ Maps over the Internet and perform a search for the individual's work place. The different actions can be scrolled through utilizing either the up and down arrows of the 5 way button or the scroll bar 104 of the right side of the screen. The right arrow of the 5 way button allows the user to view and/or edit the content of a highlighted item. The left arrow allows the user to return to the previous screen. This is set forth in FIGS. 5B and 6B. The lower portion of the screen 102 has two virtual buttons. Activation of these buttons will dial the contact's mobile or work phone. The phone numbers associated with these buttons can be changed by the user of the device. Each contact has a default phone number associated with the individual. This is normally the phone number associated with the left button on the lower portion of the screen. This number can also be dialed by pressing the green phone “dialing” icon of the cell phone.

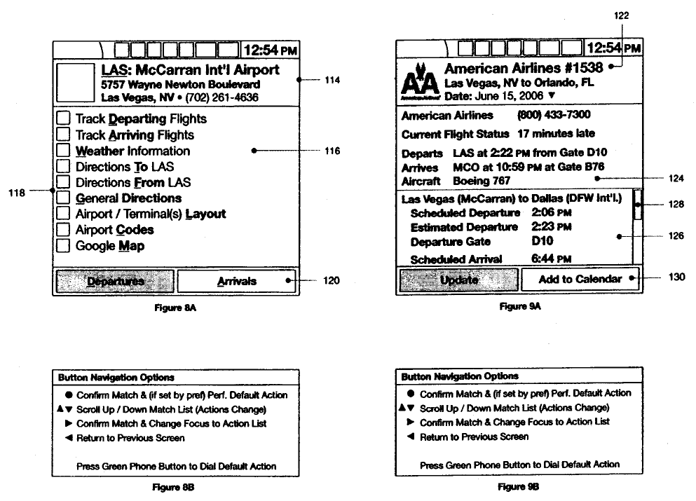

If the search performed by the user results in a return of records rather that an application the results displayed are similar to those illustrated in FIG. 7A. This example is the result of a search utilizing the letters CAR. All of the files containing any reference with CAR are displayed on portion 106 of the screen. The word containing CAR is displayed and underlined so the user can determine what each file pertains to. In the illustrated example in addition to a contact person Beth Carson, the movie “Cars” by Walt Disney pictures, the song “Carolina In My Mind” by James Taylor and a photo of Amy's new “car” are displayed as files relating to CAR. An upper portion 110 of the screen contains information related to whatever item is highlighted in portion 106 of the screen. If the highlighted item or person has not been selected the portion 110 of the screen will be grayed out to indicate that a selection has not been made. Action boxes 108 are positioned alongside each file so that individual files can be selected and opened. Whenever an item is selected the details and description of the item are displayed in portion 110 of the screen. FIG. 7B illustrates the different functions available to the user with respect to the screen being displayed. In the illustrated example, the 5 way button can be used to scroll up or down the list of retrieved files, the right arrow is used to confirm the match and open the selected file, the left arrow returns the user to the previous screen and the green phone “dialing” icon allows the user to dial a default phone number associated with a person if a person is selected. The virtual buttons in the lower portion 112 of the screen will also dial selected phone numbers of individuals if these individuals are selected.

If the user had selected “Cities” from the results list after the letter “C” was entered then the initial search criteria the letter C would be cleared because this is considered to be a Category as opposed to an Application. The user could then enter “NY” to obtain information regarding “New York City.” If the user is requesting information about a city which is not in the database the software would indicate that the user should perform a search on the Internet and provide the user with access to the Internet. In the illustrated example the letters LAS were entered after Cities was selected. Information relating to Las Vegas Nev. was displayed and the user selected information relating to McCarran International Airport, as illustrated in FIG. 8A. After this selection was made the name, address and phone number of the airport are displayed in the upper portion 114 of the screen. Different actions relating to the airport are displayed in the action list portion 116 of the screen. This is similar in function to the action list in FIG. 5A. The different action can be selected by highlighting them using the 5 way button, touching the action box 118 associated with each action or entering the letter which is capitalized, bolded and underlined in each action on the keyboard. Two virtual buttons on the lower portion 120 of the screen quickly connect the user to departing and arriving flights at the airport. FIG. 8B lists the different functions associated with the 5 way button and the screen of FIG. 8A.

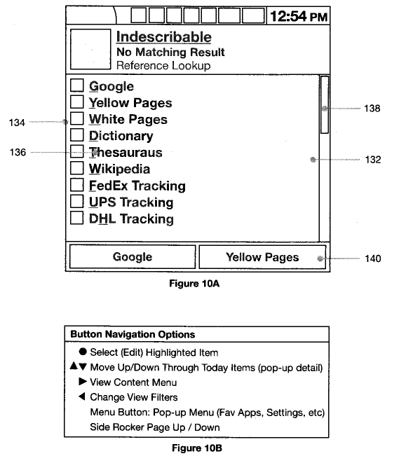

FIG. 9A illustrates information which has been retrieved with respect to a specific flight on a specific airline. The airline, flight number, departure and arrival cities and current date are listed in upper portion 122 of the screen. A more complete listing of information relating to the selected flight is displayed in portion 124 of the screen. This includes the departing and arriving gate information type of aircraft and current flight status. This information was obtained through a connection over the Internet to the specific airline. Additional flights departing from McCarran airport are listed in portion 126 of the screen. A scroll bar 128 permits the user to scroll through the listed flights. They can be highlighted and additional information regarding certain flights obtained. There are two virtual buttons in the lower portion 130 of the screen. These buttons can be used to connect to the Internet to update the information regarding a specific flight or add a specific flight to the user's calendar after a ticket has been purchased. FIG. 9B illustrates how the user can navigate screen 9A utilizing the 5 way button and the green phone “dial” button.

Another example of a category file would be if the user entered the letter “P” and then selected “Package Tracking” from the results presented. Next the user would enter the letter and number sequence assigned to a specific package. The device would recognize that a connection to a remote server was required and initiate a wireless connection to a remote server managed by the freight shipment company associated with the information entered by the user. The status of the package and its location would then be delivered to the user's device and displayed thereon.

If no satisfactory results were obtained from a user's search then the user could indicate that they would want to be connected to the Internet and continue searching. At this point the screen illustrated in FIG. 10A appears. A list of frequently used Internet Web sites is displayed in portion 132 of the screen. Each listing has an associated action box 134 by which the associated listing can be selected and activated. Each listing also contains a word with a capitalized and underlined letter 136. If this letter is entered on the keyboard of the device the associated action will be selected and activated. A scroll bar 138 allows the user to scroll through the items listed in area 132 of the screen. The bottom portion 140 of the screen contains two virtual buttons. These connect the user to the most frequently used listings. FIG. 10B illustrates the functions of the 5 way button and other controls associated with the screen of 10A.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A computer implemented method of retrieving information from a database or other source of information comprising:
indexing said information;
prioritizing said indexed information;
communication a first request for said information to said database or said other source;
retrieving said information and selecting desirable information obtained from said first request;
if no desirable information is available from said first request then modifying said first request and submitting a second request.

2. The method of claim 1, further comprising:
determining if said retrieved information is in the form of an application, a category or a record.

3. The method of claim of claim 2, wherein when said retrieved information is in the form of an application running the application to retrieve selected data.

4. The method of claim 2, wherein when said retrieved information is in the form of a record, accessing data associated with said record.

5. The method of claim 2, wherein when said retrieved information is in the form of a category clearing said previous search request and entering a new search request for information located within said category.

6. The method of claim 2, wherein when said retrieved information is in the form of a category providing a listing of the information in the category and selecting specific information from said listing.

7. The method of claim 1, further comprising making a determination that said initial search requests have not yielded satisfactory results;
accessing the Internet and entering another search request.

8. The method of claim 1, further comprising retrieving the same information from different categories using different search techniques.

9. The method of claim 1, wherein said prioritizing of said indexed information is based on a criteria established by a user of said database.

10. The method of claim 1, wherein said prioritizing of said indexed information is based on criteria contained in the software performing the search.

11. The method of claim 1 wherein said first request is an alphabetic character.

12. The method of claim 11 wherein said second request is an alphabetic character.

13. The method of claim 1 wherein said other source of information comprises a removable media card.

14. The method of claim 1, further comprising accessing the Internet and updating the information in said database.

15. A device for retrieving information from a database or other source of information comprising:
means for indexing said information;
means for prioritizing said indexed information;
means to communicate a first request for said information to said database or said other source;
means to retrieve said information and selecting desirable information obtained from said first request;
means to modify said first request and submit a second request if no desirable information is available from said first request.

16. The device of claim 15 further comprising:
means to determine if said retrieved information is in the form of an application, a category or a record.

17. The device of claim 16, wherein when said retrieved information is in the form of an application further including means to run the application to retrieve selected data.

18. The device of claim 16, wherein when said retrieved information is in the form of a record further including means to access data associated with said record.

19. The device of claim 16 wherein when said retrieved information is in the form of a category further including means to clear said previous search request and entering a new search request for information located within said category.

20. The device of claim 16, wherein when said retrieved information is in the form of a category further including means for providing a listing of the information in the category and means for selecting specific information from said listing.

21. The device of claim 15, further comprising means for making a determination that said initial search requests have not yielded satisfactory results;
means for accessing the Internet
and means for entering another search request.

22. The device of claim 15, further comprising means for retrieving the same information from different categories using different search techniques.

23. The device of claim 15, wherein said means to prioritize said indexed information further includes a criteria established by a user of said database.

24. The device of claim 15 wherein said first request is an alphabetic character.

25. The device of claim 15 wherein said second request is an alphabetic character.

26. The device of claim 15 wherein said other source of information comprises a removable media card.

27. The device of claim 15, further comprising means to access the Internet and update the information in said database.

28. The device of claim 16 wherein said device is a smartphone, said smartphone including a keypad with means to navigate through said application, category or record and retrieve said information.

29. The device of claim 16 wherein said device is a smartphone, said smartphone including a touch screen provided with means to navigate through said application, category or record and retrieve said information.
